(19) United States
(12) Patent Application Publication
(10) Pub. No.: US 2025/0242395 A1
(43) Pub. Date: Jul. 31, 2025

(54) CHEMICAL FUME HOOD PERSONAL GUARD

(71) Applicant: SAUDI ARABIAN OIL COMPANY, Dhahran (SA)

(72) Inventors: Othman Saleh ALKUBAISI, Dhahran (SA); Luay Kamal QTAISH, Dhahran (SA)

(73) Assignee: SAUDI ARABIAN OIL COMPANY, Dhahran (SA)

(21) Appl. No.: 18/423,100

(22) Filed: Jan. 25, 2024

(51) Int. Cl. B08B 15/02

(52) U.S. Cl. CPC B08B 15/023

(57) ABSTRACT

A system includes a chemical fume hood with a work chamber, an access window providing access to the work chamber for a user in a breathing environment exterior to the chemical fume hood and a sash movable from an open position to a closed position. The system may further include a personal guard assembly. The personal guard assembly may include a portable monitoring sensor operable to detect a concentration of a chemical within the breathing environment, an actuator operably coupled to the sash to move the sash between the open and closed positions and a controller operably coupled to the personal monitoring sensor to receive a signal indicative of the concentration of the chemical detected thereby, and operably coupled to the actuator to instruct the actuator to move the sash to the closed position in response to determining that the concentration of the chemical meets or exceeds a predetermined threshold.

### FIELD OF THE DISCLOSURE

The present disclosure relates generally to laboratory chemical fume hoods for removal of airborne contaminants generated by laboratory processes performed within a work chamber of the chemical fume hood, and more particularly, to systems to protect operators from accidental releases of the airborne contaminants from the work chamber.

### BACKGROUND OF THE DISCLOSURE

Chemical fume hoods are used in laboratories and research and development (R&D) facilities to protect scientists, technicians and other users from exposure to dangerous chemicals that may be used in, or byproducts of, various experiments and tests. Usually, chemical fume hoods are equipped with a partially contained work chamber where the experiments and tests may be conducted. The air quality within the work chamber may be monitored, and airflow out of the work chamber may be controlled and filtered to prevent hazardous conditions from arising. In some instances, the chemical fume hood may include a sash that may be closed when a dangerous condition is detected to isolate the work chamber from the surrounding environment.

In laboratories and R&D facilities where chemical tests for crude oil and refined oil products are conducted, technicians and other users may be frequently exposed to toxic volatile organic compounds (VOCs) at varying concentration levels. Although these VOCs might not exceed the Occupational Exposure Levels (OELs) recommended by regulatory organizations such as the Occupational Safety and Health Administration (OSHA) or the National Institute for Occupational Safety and Health (NIOSH), some are classified as carcinogens and are potentially toxic at very low levels. Accordingly, any exposure to these harmful VOCs should be avoided if reasonably achievable.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a chemical fume hood system, includes a chemical fume hood and a personal guard assembly. The chemical fume hood includes a work chamber for conducting laboratory procedures therein, an access window providing access to the work chamber for a user in a breathing environment exterior to the chemical fume hood and a sash movable within the access window from an open position wherein the work chamber is accessible through the access window and a closed position wherein the work chamber is isolated from the breathing environment. The a personal guard assembly includes a portable monitoring sensor operable to detect a concentration of a chemical within the breathing environment exterior to the chemical fume hood, an actuator operably coupled to the sash to move the sash between the open and closed positions and a controller operably coupled to the personal monitoring sensor to receive a signal indicative of the concentration of the chemical detected thereby, and operably coupled to the actuator to instruct the actuator to move the sash to the closed position in response to determining that the concentration of the chemical meets or exceeds a predetermined threshold.

According to another embodiment consistent with the present disclosure, a method for conducting a laboratory procedure within a chemical fume hood system includes (a) affixing a monitoring sensor to a user, the monitoring sensor operable to detect a concentration of a chemical within the breathing environment of the user exterior to a work chamber within a chemical fume hood, (b) detecting the concentration of the chemical within the breathing environment with the monitoring sensor and transmitting the concentration to a controller, (c) determining whether the concentration meets or exceeds a predetermined threshold with the controller and (d) transmitting a command signal from the controller to an actuator to close a sash and thereby isolate the work chamber from the breathing environment in response to determining the concentration meets or exceeds the predetermined threshold.

According to another embodiment consistent with the present disclosure, a personal guard assembly for a chemical fume hood includes a portable monitoring sensor operable to detect a concentration of a chemical within a breathing environment exterior to a work chamber defined within the chemical fume hood, an actuator for operably coupling to a sash of the chemical fume to move the sash between open and closed positions to thereby provide access to the work chamber and isolate the work chamber from the breathing environment, respectively and a controller operably coupled to the personal monitoring sensor to receive a signal indicative of the concentration of the chemical detected thereby, and operably coupled to the actuator to instruct the actuator to move the sash to the closed position in response to determining that the concentration of the chemical meets or exceeds a predetermined threshold.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic pictorial diagram of a chemical fume hood system including a personal guard assembly with a monitoring sensor carried by a user in accordance with one or more aspects of the present disclosure.

FIG. 2 is a schematic pictorial diagram of the chemical fume hood system of FIG. 1 during a chemical release event.

FIG. 3 is a schematic symbolic diagram of the chemical fume hood system of FIG. 1 illustrating a controller for controlling a response of the personal guard assembly to a chemical release event or other detectable conditions.

FIG. 4 is a flowchart illustrating an example procedure for use of the chemical fume hood system of FIG. 1 in accordance with one or more aspects of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a chemical fume hood system with a personal guard assembly. The personal guard assembly may include a monitoring sensor that is affixed on a scientist's, technician's or other user's laboratory coat working outside a work chamber of the chemical fume hood. The monitoring sensor may be operable to detect VOCs or other chemicals present in the direct breathing environment of the user. Where the monitoring sensor detects a chemical concentration above a predetermined set point, an alert may be provided to the user to allow the user to take remedial action. In some embodiments, a sash on the chemical fume hood may close automatically to isolate the work chamber in response to the chemical concentration detected outside work chamber being above a predetermined threshold.

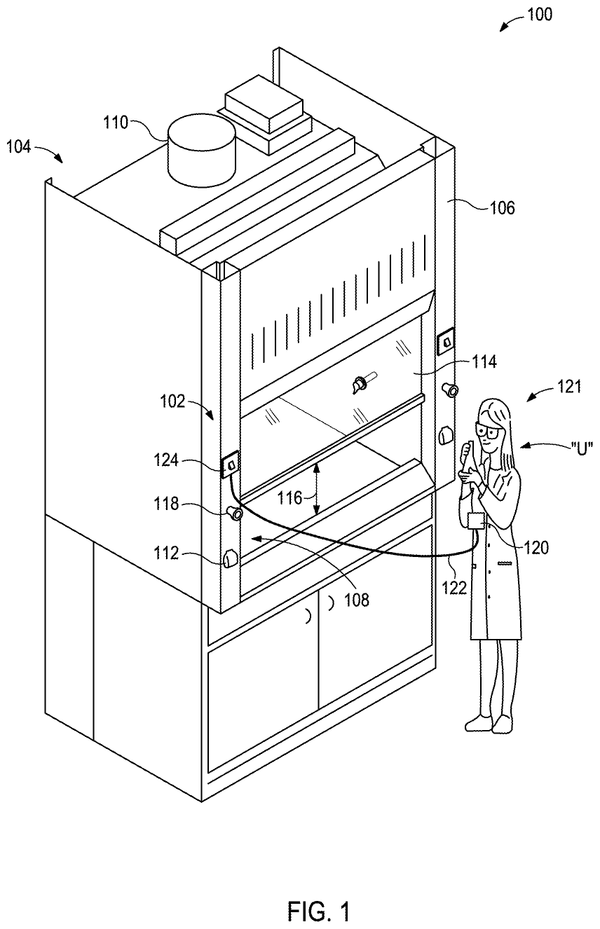

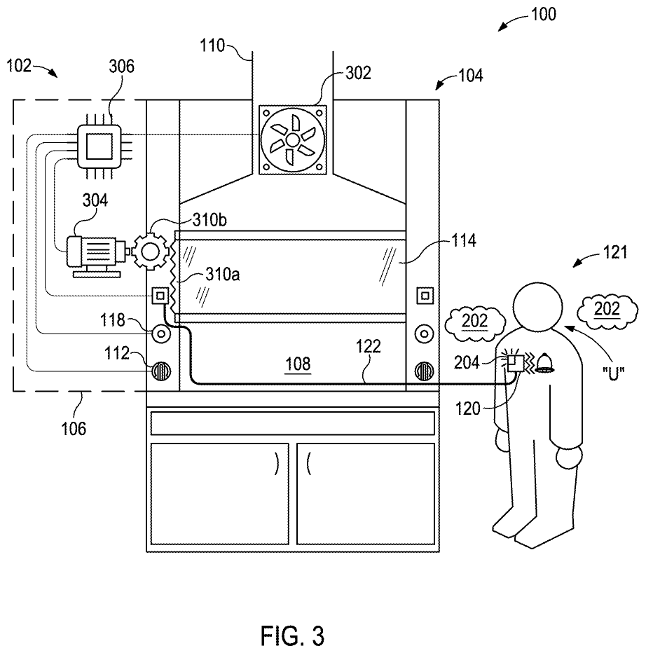

FIG. 1 is a schematic diagram of an example chemical fume hood system 100 including a personal guard assembly 102 in accordance with aspects of the present disclosure. The system 100 generally includes a chemical fume hood 104 and the personal guard assembly 102 interconnected therein and therewith. The chemical fume hood 104 generally includes a housing 106 defining an interior work chamber 108 therein. The work chamber 108 is arranged for conducting chemical experiments and other laboratory processes. In the embodiment illustrated, the work chamber 108 is fluidly coupled to an exhaust duct 110 through which airborne chemicals may be safely extracted from the work chamber 108. The exhaust duct 110 may extend to a filtration unit (not shown) or vent to an outdoor location. In other embodiments, a filtration unit (not shown) may be provided within a ductless chemical fume hood without departing from the scope of the disclosure. As described in greater detail below, airflow out of the work chamber 108 may be selectively driven by a fan 302 (FIG. 3) coupled between the interior work chamber 108 and the exhaust duct 110. Manual fan speed controls 112 may be positioned on a front face of the housing 106 such that the fan speed controls 112 may be accessible to a user “U” of the chemical fume hood 104.

The housing 106 includes a sash 114, which is vertically movable within an access window 116 to selectively isolate, and provide access to, the work chamber 108. In other embodiments, a sash may move horizontally, rotationally or in any other direction without departing from the scope of the disclosure. With the sash 114 in an open position, as illustrated in FIG. 1, the user “U” may access the work chamber 108 through the access window 116 to manually handle chemicals or other laboratory equipment disposed therein. The sash 114 may be moved downwardly to a closed position where the access window 116 is closed by the sash 114 and the work chamber 108 is sealed and/or isolated from the user “U.” As described in greater detail below, movement of the sash 114 may be selectively driven by an electric motor 304 (FIG. 3) or other actuator. Manual sash controls 118 may be positioned on the front face of the housing 104 such that the user “U” may adjust the sash controls 118 to open or close the sash 114 by operating the motor 304. The sash 114 may also be closed by manually handling or otherwise operating the sash 114 directly. With the sash 114 in the closed position, any airborne chemical contaminants within the work chamber 106 may safely be extracted through the exhaust duct 110, and thereafter, the sash 114 may be reopened.

The personal guard assembly 102 includes a portable monitoring sensor 120, which may be carried by the user “U.” The monitoring sensor 120 may be affixed to the user with fasteners such pins, lanyards, hook and loop fasteners, and/or may be placed in a pocket on a lab coat worn by the user “U.” Thus, the monitoring sensor 120 may be carried in a breathing environment 121 of the “U” directly outside chemical fume hood 104, and may be operable to detect dangerous conditions therein. The monitoring sensor 120 may be chemical sensor such as a VOC detector, an odorous gas sensor module, an ion mobility sensor, etc. For example, the monitoring sensor may be a metal oxide semiconductor (MOS) sensor that uses a delicate film to detect compounds such as benzene, ethanol and toluene in the surrounding atmosphere (breathing environment 121). Although the monitoring sensor 120 is described herein as detecting VOCs, it should be appreciated that the monitoring sensor 120 may detect other types of chemicals without departing from the scope of the disclosure.

In the embodiment illustrated in FIG. 1, the monitoring sensor 120 is tethered to the chemical fume hood 104 by a cable 122. The cable 122 may include electrical wires extending therethrough and operable to transmit signals indicative of a concentration of chemicals in the atmosphere surrounding the monitoring sensor 120. The cable 122 extends to a sensor mount 124 on the front face of the housing 106 where the monitoring sensor 120 may be supported when the chemical fume hood 104 is not in use. The cable 122 offers a wired communication between the monitoring sensor 120 and a controller 306 (FIG. 3), which may be disposed within the housing 106 of the chemical fume hood 104. Wired communication may be extremely rapid and reliable, but in other embodiments the monitoring sensor 120 may be wirelessly communicatively coupled to the controller 306.

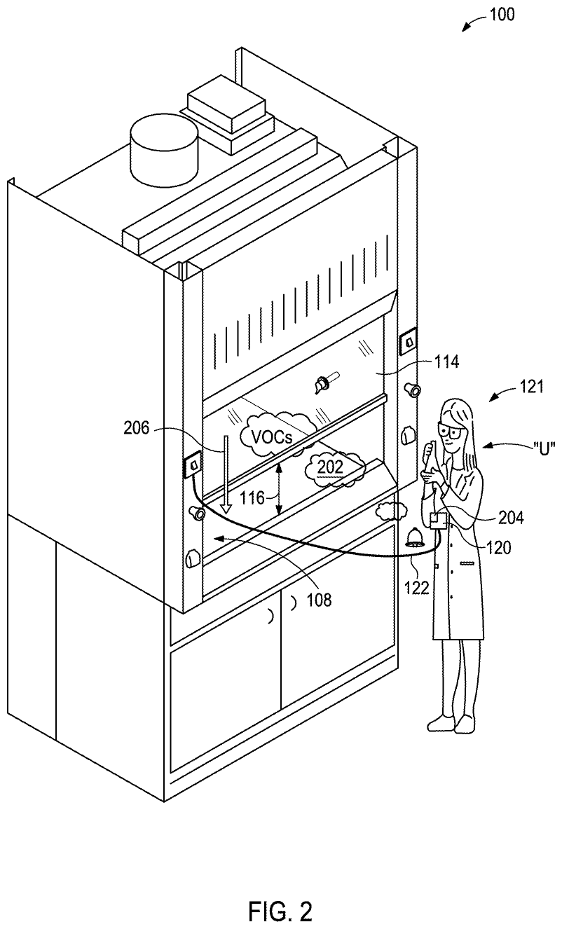

FIG. 2 is a schematic pictorial diagram of the chemical fume hood system 100 during a chemical release event. VOCs 202 or other chemicals have escaped from the work chamber 108 through the access window 116 and entered a breathing environment 204 of the user “U.” A chemical release event may occur, e.g., when an improper fan speed is set. For example, if a speed of the fan 302 (FIG. 3) is too low, the VOCs 202 may not be effectively drawn through the exhaust duct 110, and may accumulate in the work chamber 108 until the VOCs 202 drift out through the access window 116. Conversely, if the speed of the fan 302 is too high, the fan 302 may create turbulent conditions within the work chamber 108 such that the VOCs back splash out through the access window 116. Also, accidental spills within the work chamber 108 may cause a chemical release event.

The VOCs 202 may be detected by the monitoring sensor 120 worn or otherwise carried by the user “U.” The monitoring sensor 120 may detect a concentration of the VOCs outside the work area 108, and transmit a signal indicative of the concentration through the cable 122. As described in greater detail below, a chemical fume hood system 100 may respond in a variety of different ways depending on the concentration of the VOCs 202 detected.

In general, if the detected concentration of the VOCs 202 is greater than a predetermined set point, an alert may be delivered to the user “U” by an alarm 204 carried by the user “U.” The alarm 204 may be a component of the monitoring sensor 120, or otherwise operatively coupled to the monitoring sensor 120. The alarm 204 may be an audio and/or visual alarm, and in some embodiments, may be operable to vibrate to alert the user “U” to specific conditions detected by the monitoring sensor 120. If the detected concentration of the VOCs 202 is greater than a predetermined threshold, e.g., a threshold greater than the predetermined set point, the personal guard assembly 102 may respond by closing the sash 114 in the direction of the arrow 206. The sash 114 may be closed at low speeds such that the user “U” may remove his or her hands from the work chamber 108 without difficulty. The closure of the sash 114 may also be accompanied by a specific response by the alarm 204. For example, the alarm 204 may vibrate to alert the user that the sash 114 is closing.

FIG. 3 is a schematic symbolic diagram of the chemical fume hood system 100 illustrating the controller 306 for controlling a response of the personal guard assembly 102 to a chemical release event or other detectable conditions. The controller 306 may disposed within the housing 106 of the chemical fume hood 104 and may be operably coupled to the monitoring sensor 120 and the alarm 204 through the cable 122. The controller 306 is operable to receive signals from the monitoring sensor 120 indicative of the concentration of the VOCs 204 or other chemicals in the breathing environment 121 of the user “U,” and operable to provide instructions (command signals) to the alarm 204. In some embodiments, the controller 306 may be a computer-based system that may include a processor, a memory storage device, and programs and instructions, accessible to the processor for executing the instructions utilizing the data stored in the memory storage device. The memory storage device of the controller 306 may include predetermined set points and thresholds (see, e.g., Table 1 below) stored therein. In some embodiments, the controller 306 may be associated with an input device (not shown) where the values of the set points and thresholds may be modified, or the instructions may be updated.

The controller 306 may also be operably coupled to manual controls such as fan speed controls 112 and sash controls 118 to receive instruction signals therefrom, and operably coupled to actuators such as the fan 302 and the motor 304 (and alarm 204) to provide instructions (command signals) thereto. The fan 302 may be instructed by the controller 306, e.g., to speed up, slow down, stop or reverse direction etc. The motor 304 may be operably coupled to the sash 114 by a rack 310a and pinion gears 310b such that operation of the motor 304 may translate the sash 114 vertically (or horizontally) within the access window 116. In other embodiments, other actuators (not shown) such as hydraulic cylinders or linear motors may be operably coupled between the controller 306 and the sash 114 to open and close the sash 114.

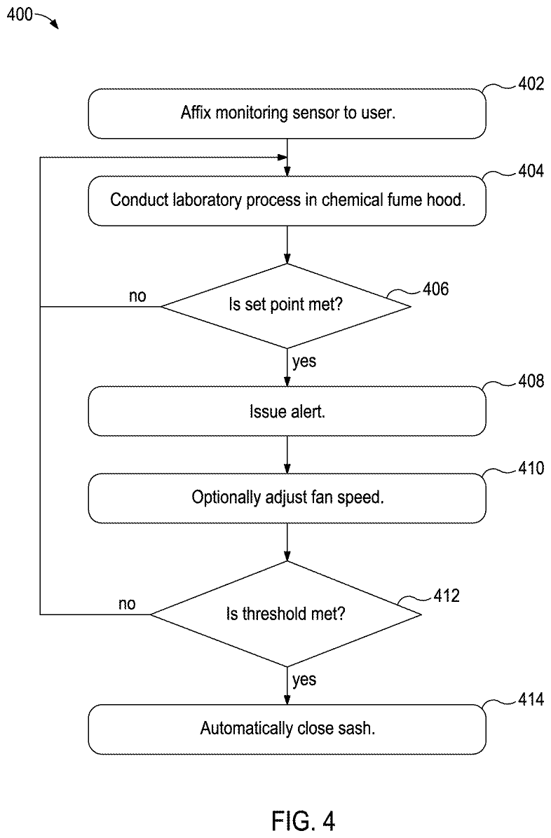

FIG. 4 is a flowchart illustrating an example procedure 400 for use of the chemical fume hood system of FIG. 1 in accordance with one or more aspects of the present disclosure. With reference to FIG. 4, and continued reference to FIGS. 1-3, the procedure 400 may begin at step 402 where the monitoring sensor 120 and/or the alarm 204 is affixed to the user “U.” The monitoring sensor 120 and alarm 204 may be removed from the sensor mount 124 when the user “U” is ready to conduct a laboratory process within the chemical fume hood 104. The monitoring sensor 120 and alarm 204 may be affixed to the user “U” with clips, pins, lanyards, hook and loop fasteners, and/or may be placed in a pocket on a lab coat or other article worn by the user “U.” In other embodiments, the monitoring sensor 120 and/or the alarm 204 may remain on the sensor mount 124 in a fully functional condition.

Next at step 404, the laboratory process may be conducted within the work chamber 108 through the access window 116. The laboratory process may include the creation and/or manipulation of chemicals and chemical components including oil and refined oil products, and expose the user “U” to potentially toxic VOCs and other hazardous chemicals. The fan 302 may extract these chemicals from the work chamber and exhaust the chemicals through the exhaust duct 110. Although the fan 302 may be functioning properly, releases of chemicals through the access window 116 may occur. Even if the VOCs or other chemicals do not exceed occupational exposure levels, they may present a danger to the user “U.”

Thus, at decision 406, a determination may be made whether the exposure levels experienced by the user “U” reach a predetermined set point. The monitoring sensor 120 may detect a concentration of one or more chemicals in the breathing environment 121 of the user “U” outside the chemical fume hood 104. The set point may be any lower limit of the concentration for which it has been determined that the user “U” should be informed. For example, a set point for a concentration in PPM (parts per million) is given for several chemicals of interest for the oil and gas industry are given in Table 1 below. The BTEX chemicals listed are compounds occurring naturally in crude oil, which have been found to have the potential to cause neurological impairment. Exposure to hydrogen sulfide, which is found naturally and associated with crude oil in hazardous concentrations, has been found to cause irritation of the eyes and respiratory system as well as fatigue, headache and more serious symptoms.

TABLE 1

| | | Threshold Limit | Alert Set Point |
|---|---|---|---|
| Chemical | | (in PPM) | (in PPM) |
| BTEX | Benzene | 0.5 | 0.1 |
| | Toluene | 20 | 10 |
| | Ethylbenzene | 20 | 10 |
| | Xylene | 100 | 20 |

| | | |
|---|---|---|
| Hydrogen Sulfide | 1 | 0.5 |

To make the determination at step 406, the concentration of the chemicals in the breathing environment 121 may be detected by the monitoring sensor 120, and a signal indicative of the concentration may be transmitted to the controller 306 through the cable 122. The controller 306 may compare the concentration to the alert set points stored therein. If the concentration is lower than the set point, the procedure 400 returns to step 404 and the laboratory procedure may continue. If the concentration meets or exceeds the set point, the procedure 400 continues to step 408 where an alert is issued. A relatively low alert set point may be selected, particularly for chemical fume hoods used in laboratories. Indoor laboratories may be relatively closed environments as compared with open-space operation plants where BTEX concentrations may be dissipated and diluted in the surrounding air. Thus, any concentrations of chemicals emitted into an indoor laboratory will significantly affect the air quality of the entire laboratory space and expose any and all personnel to hazardous conditions.

At step 408, the alarm 204 may issue an audio, visual and or vibratory alert to indicate to the user “U” that the alert set point has been met. For example, the alarm 204 may light up, issue a pattern of audio beeps, momentarily vibrate and/or provide other signals to the user “U.” The user “U” may thereby be alerted to assess the danger, possible causes and consider remedial actions. For example the procedure 400 may continue to step 410 where the speed of the fan 30 may be adjusted. The increased or decreased by either the controller 306 and/or the user “U” manipulating the fan speed controls 112. The concentrations of the chemicals in breathing environment 121 may continue to be monitored by the monitoring sensor 120.

The procedure 400 may then proceed to decision 412 where it may be determined whether a predetermined threshold has been met. The predetermined threshold may be greater than the predetermined alert set point for each specific chemical (see Table 1 above), and may represent a concentration of the chemical that has been determined to present a pressing risk of continuing the laboratory process. Similar to decision 406 described above, the monitoring sensor 120 may detect the concentration of the chemical in the breathing environment 121 of the user “U,” and transmit a signal indicative of the concentration to the controller 306. The controller 306 compares the concentration to the predetermined threshold.

If the threshold has not been met, the procedure may return to step 404 where the laboratory process may continue. If the controller 306 determines that the threshold has been met or exceeded, the procedure proceeds to step 414 where the sash 114 may be automatically closed. The controller 306 may send a command signal to the motor 304 to begin closing the sash 114. In some embodiments, the sash 114 may be closed relatively slowly, e.g., over a time period of 15 seconds or more. Simultaneously or prior to instructing the motor 304, the controller 306 may send a command signal to the alarm 204 to provide or intensify an alert issued to the user “U.” For example, the alarm may be instructed to vibrate continuously until the sash 114 is completely closed. The continuous vibration may alert the user “U” to remove his or her hands from the work chamber 108 before the sash 114 can engage the user “U.” In this manner, the personal guard assembly 102 may protect the user “U” in the event of a chemical release event, even if only a small concentration of the VOCs or other chemicals are released.

Embodiments disclosed herein include:

A. A chemical fume hood system, can include a chemical fume hood and a personal guard assembly. The chemical fume hood can include a work chamber for conducting laboratory procedures therein, an access window providing access to the work chamber for a user in a breathing environment exterior to the chemical fume hood and a sash movable within the access window from an open position wherein the work chamber is accessible through the access window and a closed position wherein the work chamber is isolated from the breathing environment. The a personal guard assembly can include a portable monitoring sensor operable to detect a concentration of a chemical within the breathing environment exterior to the chemical fume hood, an actuator operably coupled to the sash to move the sash between the open and closed positions and a controller operably coupled to the personal monitoring sensor to receive a signal indicative of the concentration of the chemical detected thereby, and operably coupled to the actuator to instruct the actuator to move the sash to the closed position in response to determining that the concentration of the chemical meets or exceeds a predetermined threshold.

B. A method for conducting a laboratory procedure within a chemical fume hood system can include (a) affixing a monitoring sensor to a user, the monitoring sensor operable to detect a concentration of a chemical within the breathing environment of the user exterior to a work chamber within a chemical fume hood, (b) detecting the concentration of the chemical within the breathing environment with the monitoring sensor and transmitting the concentration to a controller, (c) determining whether the concentration meets or exceeds a predetermined threshold with the controller and (d) transmitting a command signal from the controller to an actuator to close a sash and thereby isolate the work chamber from the breathing environment in response to determining the concentration meets or exceeds the predetermined threshold.

C. A personal guard assembly for a chemical fume hood can include a portable monitoring sensor operable to detect a concentration of a chemical within a breathing environment exterior to a work chamber defined within the chemical fume hood, an actuator for operably coupling to a sash of the chemical fume to move the sash between open and closed positions to thereby provide access to the work chamber and isolate the work chamber from the breathing environment, respectively and a controller operably coupled to the personal monitoring sensor to receive a signal indicative of the concentration of the chemical detected thereby, and operably coupled to the actuator to instruct the actuator to move the sash to the closed position in response to determining that the concentration of the chemical meets or exceeds a predetermined threshold.

Each of embodiments A, B, and C may have one or more of the following additional elements in any combination: Element 1: wherein the personal guard assembly further comprises an alarm operably coupled to the controller, and wherein the controller is operable to instruct the alarm to issue an alert in response to instructing the actuator to move the sash to the closed position. Element 2: wherein the controller is operable to instruct the alarm to issue an alert in response to determining that the concentration of the chemical meets or exceeds an alert set point less than the predetermined threshold. Element 3: wherein the personal guard assembly further comprises a cable operably coupling the monitoring sensor and the alarm to the controller. Element 4: wherein the monitoring sensor includes a fastener for affixing the monitoring sensor to the user. Element 5: wherein the chemical fume hood further comprises a fan operably coupled to the controller, and wherein the controller is operable to adjust a speed of the fan and thereby adjust extraction of air from the work chamber. Element 6: wherein the chemical fume hood further comprises manual fan speed controls operably coupled to the controller. Element 7 wherein the monitoring sensor is operable to detect a concentration of at least one of the group consisting of benzene, toluene, ethylbenzene, xylene and hydrogen sulfide.

Element 8: further comprising transmitting a command signal from the controller to an alarm to instruct the alarm to issue an alert in response to instructing the actuator to move the sash to the closed position. Element 9: further comprising instructing the alarm to issue an alert in response to determining that the concentration of the chemical meets or exceeds an alert set point less than the predetermined threshold. Element 10: wherein transmitting the concentration to the controller and instructing the alarm comprises transmitting signals through a cable operably coupling the monitoring sensor and the alarm to the controller. Element 11: further comprising adjusting a speed of a fan with the controller to thereby adjust extraction of air from the work chamber. Element 12: wherein detecting the concentration of the chemical comprises detecting the concentration of at least one of the group consisting of benzene, toluene, ethylbenzene, xylene and hydrogen sulfide.

Element 13: further comprising an alarm operably coupled to the controller, and wherein the controller is operable to instruct the alarm to issue an alert in response to instructing the actuator to move the sash to the closed position. Element 14: wherein the controller is operable to instruct the alarm to issue an alert in response to determining that the concentration of the chemical meets or exceeds an alert set point less than the predetermined threshold. Element 15: further comprising a cable operably coupling the monitoring sensor and the alarm to the controller. Element 16: wherein the monitoring sensor includes a fastener for affixing the monitoring sensor to the user. Element 17: wherein the monitoring sensor is operable to detect a concentration of at least one of the group consisting of benzene, toluene, ethylbenzene, xylene and hydrogen sulfide.

By way of non-limiting example, exemplary combinations applicable to A, B, and C include: Element 1 with Element 2; Element 2 with Element 3; Element 3 with Element 4; Element 5 with Element 6; Element 8 with Element 9; Element 9 with Element 10; Element 14 with Element 15; and Element 15 with Element 16.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or operator. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A chemical fume hood system, comprising:
a chemical fume hood, comprising:
a work chamber for conducting laboratory procedures therein;
an access window providing access to the work chamber for a user in a breathing environment exterior to the chemical fume hood; and
a sash movable within the access window from an open position wherein the work chamber is accessible through the access window and a closed position wherein the work chamber is isolated from the breathing environment; and
a personal guard assembly, comprising:
a portable monitoring sensor operable to detect a concentration of a chemical within the breathing environment exterior to the chemical fume hood;
an actuator operably coupled to the sash to move the sash between the open and closed positions; and
a controller operably coupled to the personal monitoring sensor to receive a signal indicative of the concentration of the chemical detected thereby, and operably coupled to the actuator to instruct the actuator to move the sash to the closed position in response to determining that the concentration of the chemical meets or exceeds a predetermined threshold.

2. The system of claim 1, wherein the personal guard assembly further comprises an alarm operably coupled to the controller, and wherein the controller is operable to instruct the alarm to issue an alert in response to instructing the actuator to move the sash to the closed position.

3. The system of claim 2, wherein the controller is operable to instruct the alarm to issue an alert in response to determining that the concentration of the chemical meets or exceeds an alert set point less than the predetermined threshold.

4. The system of claim 3, wherein the personal guard assembly further comprises a cable operably coupling the monitoring sensor and the alarm to the controller.

5. The system of claim 4, wherein the monitoring sensor includes a fastener for affixing the monitoring sensor to the user.

6. The system of claim 1, wherein the chemical fume hood further comprises a fan operably coupled to the controller, and wherein the controller is operable to adjust a speed of the fan and thereby adjust extraction of air from the work chamber.

7. The system of claim 6, wherein the chemical fume hood further comprises manual fan speed controls operably coupled to the controller.

8. The system of claim 1, wherein the monitoring sensor is operable to detect a concentration of at least one of the group consisting of benzene, toluene, ethylbenzene, xylene and hydrogen sulfide.

9. A method for conducting a laboratory procedure within a chemical fume hood system, the method comprising:
affixing a monitoring sensor to a user, the monitoring sensor operable to detect a concentration of a chemical within the breathing environment of the user exterior to a work chamber within a chemical fume hood;
detecting the concentration of the chemical within the breathing environment with the monitoring sensor and transmitting the concentration to a controller;
determining whether the concentration meets or exceeds a predetermined threshold with the controller; and
transmitting a command signal from the controller to an actuator to close a sash and thereby isolate the work chamber from the breathing environment in response to determining the concentration meets or exceeds the predetermined threshold.

10. The method of claim 9, further comprising transmitting a command signal from the controller to an alarm to instruct the alarm to issue an alert in response to instructing the actuator to move the sash to the closed position.

11. The method of claim 10, further comprising instructing the alarm to issue an alert in response to determining that the concentration of the chemical meets or exceeds an alert set point less than the predetermined threshold.

12. The method of claim 11, wherein transmitting the concentration to the controller and instructing the alarm comprises transmitting signals through a cable operably coupling the monitoring sensor and the alarm to the controller.

13. The method of claim 9, further comprising adjusting a speed of a fan with the controller to thereby adjust extraction of air from the work chamber.

14. The method of claim 9, wherein detecting the concentration of the chemical comprises detecting the concentration of at least one of the group consisting of benzene, toluene, ethylbenzene, xylene and hydrogen sulfide.

15. A personal guard assembly for a chemical fume hood, the personal guard assembly comprising:
a portable monitoring sensor operable to detect a concentration of a chemical within a breathing environment exterior to a work chamber defined within the chemical fume hood;
an actuator for operably coupling to a sash of the chemical fume to move the sash between open and closed positions to thereby provide access to the work chamber and isolate the work chamber from the breathing environment, respectively; and
a controller operably coupled to the personal monitoring sensor to receive a signal indicative of the concentration of the chemical detected thereby, and operably coupled to the actuator to instruct the actuator to move the sash to the closed position in response to determining that the concentration of the chemical meets or exceeds a predetermined threshold.

16. The assembly of claim 15, further comprising an alarm operably coupled to the controller, and wherein the controller is operable to instruct the alarm to issue an alert in response to instructing the actuator to move the sash to the closed position.

17. The assembly of claim 16, wherein the controller is operable to instruct the alarm to issue an alert in response to determining that the concentration of the chemical meets or exceeds an alert set point less than the predetermined threshold.

18. The assembly of claim 17, further comprising a cable operably coupling the monitoring sensor and the alarm to the controller.

19. The assembly of claim 18, wherein the monitoring sensor includes a fastener for affixing the monitoring sensor to the user.

20. The assembly of claim 15, wherein the monitoring sensor is operable to detect a concentration of at least one of the group consisting of benzene, toluene, ethylbenzene, xylene and hydrogen sulfide.
